(19) United States
(12) Patent Application Publication
(10) Pub. No.: US 2007/0198352 A1
(43) Pub. Date: Aug. 23, 2007

(54) Transactional system for eliminating the necessity of third party loyalty benefit processors

(76) Inventor: Sheldon Kannegiesser, Santa Barbara, CA (US)

Correspondence Address: EDWIN TARVER, 16830 Ventura Blvd., SUITE 360, Encino, CA, 91436, US

(21) Appl. No.: 11/704,609

(22) Filed: Feb. 8, 2007

Related U.S. Application Data
(60) Provisional application No. 60/771,764, filed on Feb. 8, 2006.

(51) Int. Cl. G06Q 30/00; G06K 5/00

(52) U.S. Cl. 705/14; 235/380

(57) ABSTRACT

A transactional system for eliminating the necessity of third party processors, who are typically employed for processing loyalty benefits obtained during various point-of-sale loyalty programs such as rebates, cashbacks, discounts, and etc. The system is to be used in conjunction with credit cards, debit cards, loyalty cards, and so on at a point of sale. The system comprising the steps of forwarding a purchase amount less of a loyalty benefit directly to the account of a merchant at a point of sale, the merchant participating in a corresponding loyalty program, forwarding the loyalty benefit to the account of a benefit recipient at the point of sale, and generating a receipt for the purchase amount at the point of sale, the receipt depicting the break up of the purchase amount.

### CROSS-REFERENCE TO RELATED APPLICATION

None

This application claims the benefit of the priority date of provisional application 60/771,764 filed on Mar. 08, 2006

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates generally to electronically coded credit, debit, stored value or membership card transactions called loyalty cards and more specifically, to a card transaction system that rewards consumers for their shopping frequency by providing rebates, discounts, points or rewards to shoppers in a manner that eliminates the necessity and cost of third party reward processors, while simultaneously paying only the net amount on each purchase to the merchant and forwarding the loyalty benefit directly to the benefit recipient.

Credit card systems that feature point of sale rebates, discounts, points, rewards, or other “loyalty benefits” as a result of certain types of purchases are well known in the art. As used herein, a rebate refers to the return of a portion of the purchase price of an item to the purchaser or another party. Discounts refer to the price of an item being specifically reduced by a predetermined amount for a person bearing a specific card or coupon. Rebates and discounts are programs designed to engender loyalty among customers.

In addition to rebates and discounts on purchases, buyers may also accumulate reward points which can be applied in a variety of ways; allowing purchasers to obtain items at a lower cost, or in some instances for free. Frequent flyer miles are an example of such a system. In addition, many credit card issuers have programs for discounts on telephone service, gasoline, or future purchases at the merchant providing the reward.

In a further development, these rewards, or “loyalty benefits” can benefit the purchaser or cardholder in another form; as a contribution to an investment savings account, college fund, or another type of account held by the cardholder. For example, U.S. Pat. No. 5,787,404 to Holmann discloses a system that provides incentives to a user to make purchases in order to fund a savings account such as a mutual fund.

Card issuers have also created affiliations with groups or organizations whose supporters or members are issued a credit card called an “affinity” card. When an affinity card is used to purchase goods and services, a percentage (usually 1%) of the total purchase price is passed on to the affinity group by the card issuer, rather than the merchant selling the goods. In such an instance, the card issuer provides the loyalty benefit to the cardholder to encourage frequent use of the card and brand loyalty to the card issuer and associated financial institution.

Merchant loyalty rebate and discount programs designed to fund savings accounts are also known in the art. They include, “Upromise” and Vesdia Corporation's “Baby Mint”. These programs redirect point of sale loyalty benefits to college savings plans. Currently, programs such as these require a billing procedure wherein merchants are invoiced for the accumulated loyalty benefits; rebates or rewards, resulting from cardholder purchases. Not only is this method of accounting archaic, but the third party processing companies facilitating these transactions charge between 30% to 70% of the Loyalty Benefit for their services. In this manner, only a fraction of the original award accrues to the benefit of the cardholder. Furthermore, smaller merchants with cash flow restrictions may not have the funds on hand when the processing company invoices them in order to collect the accumulated rewards, creating a collection problem.

Therefore it is an object of the present invention to provide a loyalty card system that generates direct and instant loyalty payments based on qualified cardholder purchases.

A further object of the present invention is to improve on existing payment card transaction systems by changing the method by which loyalty benefits are collected and forwarded to the benefit recipient. These and other objects of the present invention will become better understood with reference to the appended Summary, Description, and Claims.

### SUMMARY

Upon making a qualified purchase, a loyalty benefit in the form of a rebate, discount, or other financial or non-financial type of reward will be issued to the card holder. In a preferred embodiment of the present invention, the loyalty benefit is held by the card Issuer and automatically forwarded directly to the benefit recipient from the card Issuer. In a further preferred embodiment of the present invention, the system provides a method to account for the loyalty benefit on the purchase receipt provided to the cardholder at the point of sale. A further methodology of this transactional system is designed to make loyalty benefits tax deductible to the cardholder when forwarded to a qualified benefit recipient; such as a nonprofit organization or health savings account in favor of the cardholder.

The loyalty card transaction system of the present invention redirects merchant point of sale rebates, discounts, points, or rewards (collectively; “loyalty benefits”) on purchase made by a cardholder directly to any previously designated benefit recipient. The benefit recipient could be the cardholder, a non-profit organization, a health savings account, a college savings account, or an insurance company for investment in an annuity in favor of the cardholder or to offset the cardholder's monthly insurance premium expense.

This transaction system is unique to the rebate and credit card industry since it can be implemented without the necessity of a third party rewards processor. Since reward processors charge a significant fee for their services (typically taking as much as 30% to 70% of the loyalty benefits provided at the point-of-sale), eliminating this step in the transaction, results in a unique and highly beneficial loyalty card system. In addition, upon approval of a purchase, the financial institution issuing the loyalty card forwards a payment to the merchant in an amount less the loyalty benefit, and forwards the loyalty benefit separately and directly to the Benefit Recipient. This transaction system contains unique methodologies that make loyalty benefits earned at the point of sale by the cardholder tax deductible when passed to certain benefit recipients, such as a non-profit organizations or a cardholder health savings account.

### BRIEF DESCRIPTION OF THE FIGURES

FIG. 1 is a block diagram illustration indicating the rebate systems currently known in the art, including the presence of a third party rewards processor.

FIG. 2 illustrates a flowchart of the method of passing point of sale rebates, discounts or rewards (“loyalty benefits”) to a benefit recipient in such a way as to eliminate the third party processor, in accordance with the present invention.

### FIGURES—REFERENCE NUMERALS

10 . . . Loyalty Card Issuer
12 . . . Cardholder
14 . . . Loyalty Card
16 . . . Merchant
18 . . . Merchant Acquiring Bank
20 . . . Third Party Processor
22 . . . Reward Recipient
24 . . . Loyalty Benefit
26 . . . Benefit Recipient

### DETAILED DESCRIPTION

The present invention comprises a transactional system, which eliminates the necessity of third party processors who are typically employed for processing loyalty benefits obtained during loyalty programs such as rebates, cashbacks, discounts, and so on. In one preferred embodiment of the present invention, a method is provided wherein a cardholder initiates a point of sale purchase using a loyalty card at any merchant participating in the loyalty program. Loyalty benefits, such as a rebate or discount related to the use of the card, are then provided to the cardholder. From the point of sale, electronic data regarding the purchase is instantaneously transmitted to the merchant's acquiring bank and then to the loyalty card issuer for approval of the purchase amount in a single transaction. The approval notification is immediately sent from the loyalty card issuer back to the merchant's acquiring bank and then to the merchant for approval of the charge or debit to the loyalty card.

One unique aspect of this transaction is that the loyalty card Issuer charges or debits the full amount of the purchase price to the Cardholder's account; but only forwards to the Merchant an amount less the loyalty benefit, which may be in the form of a rebate, discount or other benefit.

For example, on a $100 point of sale purchase, assuming a merchant is contracted to provide a 10% rebate in settling the transaction, only $90 would be forwarded to the merchant by the card issuer. This highly efficient method of conducting point of sale payments on loyalty card transactions eliminates the necessity for third party rewards processors, and the added expense of invoicing the merchant or merchant's acquiring bank at a later date in order to receive the loyalty benefit.

In another preferred embodiment of the present invention, a method is provided wherein the card Issuer, upon charging a cardholder's account the full amount of any point of sale purchase, automatically retains the loyalty benefit amount, not paying the sum to the merchant or to a third party processor (for sorting and later disbursement). Rather, the loyalty benefit amount in this instance is either forwarded immediately and directly from the card issuer to the benefit recipient or held in a custodial account by the card issuer, on behalf of the cardholder, to be forwarded to the benefit recipient when the custodial account has reached a certain threshold. This embodiment anticipates that the benefit recipient may not be the same party as the cardholder, but rather a group or organization designated by the cardholder to receive benefits.

In another aspect of the present invention, if the point of sale loyalty benefit consists of a discount. Rather than directing the merchant to calculate the discount at the point of sale (either manually or by means of an electronic coding system applied to the item to be purchased), a means is provided for the merchant, the merchants acquiring bank and the card Issuer to automatically recognize the transaction as one subject to a point of sale discount. Upon approval of the charge and settling the purchase, the card issuer automatically charges the cardholders account the full retail amount of the purchased item, but pays the merchant only the discounted amount.

The overage charged to the cardholders account by the card issuer is then either forwarded directly to the benefit recipient or held in a custodial account by the card issuer on behalf of the cardholder, to be forwarded to the benefit recipient when the custodial account has reached certain threshold criteria. This transaction is designed to occur and appear as a single charge to the cardholder's account or be conducted as two automatic charges; one to pay the merchant and an add-on charge equivalent to the discount. An additional benefit to this type of discount transaction flow as compared to a rebate is that it may allow the cardholder to alter sales tax, basing the calculation on the reduced purchase amount.

In another embodiment of the present invention, electronic data is provided to the loyalty card Issuer, listing all merchants enrolled in the loyalty benefit program, the amount of the loyalty benefit(s), and the identity of the final benefit recipient. Furthermore, the merchant's acquiring bank would be provided the same electronic data. Since the acquiring bank and merchant share the same data as the loyalty card issuer, sales receipts that reflect the loyalty benefit (rebate, discount, or reward amount) can be furnished to the cardholder at the time of purchase. This provides a detailed record of the benefit transaction, and allows the cardholder to recognize the benefits of using the loyalty card. Retained receipts can also be used to verify the accuracy of monthly statements related to the loyalty card. Additionally, it may be possible for cardholders to pay reduced sales tax based on the reduced purchase amount.

Since cardholders will shop at a variety of merchant locations, a plurality of merchant acquiring banks will process transactions for individual loyalty card issuers. As a result, each merchant acquiring bank will be able to recognize individual loyalty card transactions and accept payment amounts with the loyalty benefits already calculated. This new way of handling a loyalty transaction is seamless since it is performed electronically and instantaneously. This method is also more efficient, saving card issuers and acquiring banks time and money in processing costs, by eliminating third party reward processors.

In another preferred embodiment of the invention, the transactional system provides a system for loyalty benefits to be passed to a benefit recipient in such a manner that they are tax deductible to the cardholder if the benefit recipient is a qualified non-profit organization or qualified tax advantaged investment account such as a health savings account. These transfers can be made directly by the card Issuer or through an agent, and are tax deductible by cardholders in amounts equal to or a substantial percentage of the loyalty benefit.

Therefore, it is the principal object of this embodiment of the invention to provide a system that can direct cardholder loyalty benefits to non-profit organizations, certain forms of investment savings accounts, or other accounts accruing to the benefit of the cardholder in such a way that the loyalty benefit is tax deductible to the cardholder.

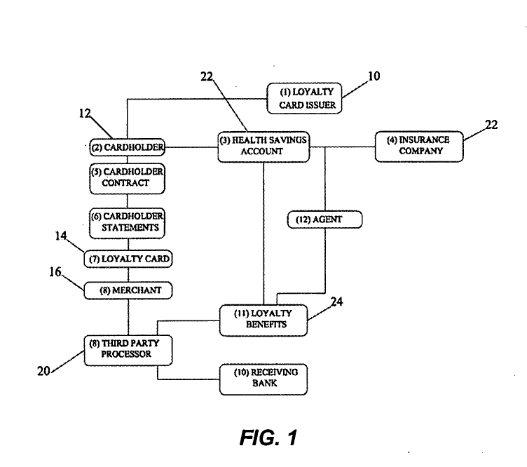

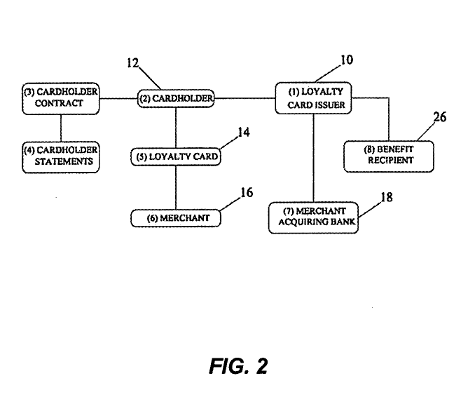

Referring to FIG. 1, a transactional system is illustrated in which loyalty benefits are generated according to the system currently known in the art. Among the changes made by the new system of the present invention, the third party processor 24 and reward recipient 26 have been eliminated, and are replaced by a merchant acquiring bank 22, loyalty benefits 30 and benefit recipient 32 in FIG. 2.

Referring to FIG. 2, the transaction system of the present invention is illustrated. In this embodiment, electronic data is provided to the loyalty card issuer 10, listing all merchants providing rebates, discounts, or rewards (collectively; “loyalty benefits”) 30, the amount of the loyalty benefit, and who the final benefit recipient 32 is. In addition, the merchant acquiring bank 22 is provided the same electronic data.

The cardholder 12 initiates a point of sale purchase at a participating merchant 20 using a loyalty card 18. From the point of sale, data regarding the purchase immediately flows to the merchant's acquiring bank 22 and then on to the loyalty card issuer 10 for approval of the purchase amount. The approval notification is then immediately sent from the loyalty card issuer 10 back to the merchant's acquiring bank 22 and the merchant 20 for approval of the charge or debit to the loyalty Card 18.

One unique aspect of the preferred embodiment of the present invention is that the loyalty card issuer 10 only forwards payments to a merchant 20 in an amount less the loyalty benefit 30 and forwards the loyalty benefit directly to the benefit recipient 32. For example, if a point of sale purchase were for $100 and the merchant 6 provided a 10% rebate or discount, then only $90 would be forwarded to the merchant 20 by the loyalty card issuer 10 and the $10 loyalty benefit would be forwarded by the loyalty card issuer 10 directly to the benefit recipient 32. This unique system eliminates the necessity for third party rewards processors (see FIG. 1). As a consequence, it eliminates the need for third party rewards processors to retrieve or process loyalty benefits from the merchant and/or the merchant's acquiring bank.

In addition, since the merchant's acquiring bank and merchant share the same data as the loyalty card issuer, it is possible for the receipt for a purchase at the point of sale to automatically reflect the loyalty benefit on the point of sale receipt provided to the cardholder at the time of purchase. This benefits cardholders since it may lower the sales tax on the purchased item.

Since cardholders 12 shop at a plurality of merchants, there will be a plurality of merchant's acquiring banks 22 for each loyalty card issuer 10. As a result, in the transactional system of the present invention, merchant's acquiring banks 22 are able to recognize each loyalty card transaction and accept for payment an amount minus the loyalty benefit. This presents a new, seamless way of handling loyalty transactions electronically and instantaneously, and is more efficient, saving card issuers and merchant's acquiring banks time and money by eliminating third party reward processors.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A transactional system which is to be used in conjunction with electronically coded cards, such as credit cards, debit cards, loyalty cards, club cards, and so on at a point of sale, so as to eliminate the necessity of third-party processors, who are typically employed for processing loyalty benefits obtained during various point-of-sale loyalty programs such as rebates, cashbacks, discounts, rewards, and etc, the system comprising the steps of:
(a) forwarding a purchase amount less of a loyalty benefit directly to the account of a merchant at a point of sale, the merchant participating in a corresponding loyalty program, the purchase amount being of a purchase made through an electronically coded card by a cardholder, who is also participating in the same loyalty program, and the loyalty benefit resulting from the fulfillment of a condition or conditions put forth by the loyalty program;
(b) forwarding the loyalty benefit to the account of a benefit recipient at the point of sale; and
(c) generating a receipt for the purchase amount at the point of sale, the receipt depicting the break up of the purchase amount.

2. The system of claim 1, wherein the benefit recipient is the cardholder.

3. The system of claim 1, wherein the loyalty benefit is initially held in a custodial account till the loyalty benefits sum up to a predetermined amount, at which point the entire sum of loyalty benefits is forwarded to the account of the benefit recipient.

4. The system of claim 3, wherein the benefit recipient is a qualified non-profit organization so that the amount transferred from the custodial account is non-taxable.

5. The system of claim 3, wherein the account of the benefit recipient refers to a qualified health savings account so that the amount transferred from the custodial account is non-taxable.

6. The system of claim 1, wherein the account of the benefit recipient refers to an investment account in annuity in favor of the cardholder.

7. The system of claim 1, wherein the account of the benefit recipient refers to a college savings account.
